(19) United States
(12) Patent Application Publication
(10) Pub. No.: US 2009/0265629 A1
(43) Pub. Date: Oct. 22, 2009

(54) SYSTEMS AND METHODS FOR EXTENDING ASSISTANCE IN A MULTI-FUNCTION PERIPHERAL DEVICE

(75) Inventor: Nehal Dantwala, Newport Beach, CA (US)

Correspondence Address: KNOBBE, MARTENS, OLSON, & BEAR, LLP, 2040 MAIN STREET, FOURTEENTH FLOOR, IRVINE, CA, 92614, US

(73) Assignee: Samsung Electronics Co., Ltd, Suwon City (KR)

(21) Appl. No.: 12/106,219

(22) Filed: Apr. 18, 2008

(51) Int. Cl. G06F 3/048

(52) U.S. Cl. 715/705

(57) ABSTRACT

Systems and methods of providing help to users of electronic devices, such as multi-function peripherals (MFPs), are disclosed. Help information is maintained in a plurality of storage devices that are in communication with a plurality of MFPs. The storage devices are configured so as to be located remotely from the MFPs. When users request assistance from an MFP, the MFP communicates with the storage devices to obtain the appropriate help information. The storage devices are further configured to allow third parties, including users of the MFPs, as well as MFP vendors, to update the help information, enhancing the assistance received by the users in response to a request for help. Should new applications be installed on the MFPs, help information associated with the new applications may be stored by the storage devices and similarly updated.

### BACKGROUND OF THE INVENTION

1. Field of the Invention

Embodiments of the present invention relate to multi-function peripherals and, in particular, to systems and methods which enhance the assistance a user receives when employing a multi-function peripheral.

2. Description of the Related Art

Multi-function peripherals (MFPs) are devices which incorporate the functionality of multiple devices in one, single device. For example, an MFP may incorporate one or more of printers, scanner, copiers, and fax machines. MFPs have recently grown in popularity, especially in small businesses and homes, due to the small amount of space they occupy in comparison to the individual devices they replace.

MFPs typically possess one or more help buttons. If there is a feature of the MFP that a user does not understand, the user can push the button which retrieves and displays help information stored by the MFP, allowing the user to obtain additional information regarding the feature and its use.

Unfortunately, the assistance provided to the user by the MFP is typically brief. For example, the assistance may comprise a description of an MFP feature. Furthermore, if the brief description is inadequate for the user's needs, the user must resort to more time consuming and difficult ways of obtaining assistance, such as consulting a user's manual or speaking with a support technician. As these approaches require greater time and resources to utilize, however, a user may instead choose to forgo their intended use of the MFP, inhibiting the user from accomplishing their goal and from using the MFP to its full potential.

From the foregoing, then, there exists an ongoing need for systems and methods which allow MFPs to provide users with assistance in using these devices.

### SUMMARY

In certain embodiments, a system incorporating a multi-function peripheral device is provided. The system comprises at least one multi-function peripheral device, at least one central help server, and a network.

The at least one multi-function peripheral device has a control interface that allows a user to provide instructions to the multi-function peripheral device which induces the device to perform copying, printing, scanning, faxing, or some combination thereof. The at least one multi-function peripheral device also includes a display where help information may be provided to the user while operating the multi-function peripheral device.

The at least central help server is in communication with the at least one multi-function peripheral device and maintains a help information that can be provided to the at least one multi-function peripheral device in response to user operation of the at least one multi-function peripheral device.

The network is configured to allow communication between the at least multi-function peripheral device and the at least one central help server. The network is further configured to allow a third party to communicate with the at least one central server and modify the help information maintained therein so that the modified help information can be provided to the user via the display in response to user manipulation of the at least one multi-function peripheral device.

In further embodiments, a method of providing assistance in use of a multi-function peripheral device having a display where help information may be provided to the user while operating the multi-function peripheral device is provided. The method comprises electronically storing a help information for the multi-function peripheral device remotely from the multi-function peripheral device. The method also comprises providing access to the remotely stored help information such that the remotely stored help information can be modified by at least one designated party. The method further comprises delivering at least a portion of the remotely stored help information to the multi-function peripheral device. The method additionally comprises displaying at least a portion of the remotely stored help information delivered to the multi-function peripheral device via the display.

In a further embodiment, a method of providing assistance in the operation of a multi-function peripheral device configured to display help information to a user of the device is provided. The method comprises sending a request for assistance from the multi-function peripheral device to at least one server located remotely from the multi-function peripheral in response to user manipulation of the multi-function peripheral device, where the server comprises a plurality of help information and a data structure containing correlations between a plurality of MFP diagnostic results and the plurality of help information. The method also comprises executing a diagnostic in response to the request for assistance to obtain at least one MFP diagnostic result. The method additionally comprises sending at least one MFP diagnostic result to the at least one server. The method also comprises electronically identifying the help information correlated with the least MFP one diagnostic result using the data structure. The method additionally comprises transmitting the correlated help information to the multi-function peripheral device. The at least one server is configured for access by at least one third party so as to permit modification of at least the help information by a third party so that modified help information can be displayed to the user.

In an additional embodiment, a multifunction peripheral device is provided. The multi-function peripheral device comprises a control interface that allows a user to provide instructions to the multi-function peripheral device which induces the device to perform copying, printing, scanning, faxing, or some combination thereof. The multi-function peripheral device further comprises a display capable of providing help information to the user while operating the multi-function peripheral device. At least a portion of the help information for the multifunction peripheral device is stored remotely from the device and where the remotely stored help information may be accessed and modified so that the modified help information can be provided to the user via the display in response to user manipulation of the at least one multi-function peripheral device.

### BRIEF DESCRIPTION OF THE DRAWINGS

FIG. 1 illustrates one embodiment of a display of an MFP device configured to provide help information to a user of the MFP;

FIG. 2 illustrates one embodiment of an assistance system for MFPs; and

FIGS. 3A-3B illustrate embodiments of methods of requesting help information and troubleshooting when employing an MFP.

### DETAILED DESCRIPTION OF CERTAIN EMBODIMENTS

Embodiments of the present disclosure pertain to systems and methods of providing help information to users of electronic devices, such as multi-function peripheral devices (MFPs). The help information is maintained in a plurality of storage devices that are in communication with a plurality of MFPs. When users request assistance from the MFPs, the MFPs communicate with the storage devices to obtain appropriate help information and display that help information to the users. In certain embodiments, the users may identify specific help information desired for retrieval and display. In alternative embodiments, the MFP may assist the user in identifying the help information for retrieval and display.

In further embodiments, the storage devices are accessible to a plurality of third parties which may modify the help information. Furthermore, the storage devices may be physically separated from the MFPs and located at a centralized access point in order to facilitate access to the storage devices. The third parties may include, but are not limited to, users of the MFPs, MFP manufacturers, and other parties selling goods or services for use with the MFPs. In this manner, when new or revised help information become available, the third parties may update the information maintained by the storage devices, allowing MFP users access to the most up-to-date help information.

The systems and methods described herein may, in additional embodiments, be employed to assist users in troubleshooting problems encountered during the use of MFPs. In one example, the storage devices maintain diagnostics capable of probing the MFPs for problems. The storage devices may further maintain troubleshooting routines capable of sending queries to the MFPs, for user response, in order to identify problems. Upon identification of a plurality of problem sources, appropriate help information, such as documentation and problem remedies, may be provided. These troubleshooting routines and diagnostics may also be updated, as necessary.

Advantageously, the disclosed embodiments significantly improve the user assistance provided by MFPs over presently available solutions. Typically, an MFP is sold to a user with a limited amount of stored help information that was available at the time of manufacture. The ability to update this stored help information is generally limited, such as through periodic firmware updates issued by the manufacturer. Furthermore, the help information stored by the MFP generally fails to include any information regarding later installed software and hardware components. As a result, the help information provided by the MFPs is controlled by the MFP manufacturer, is infrequently updated, and can lack support for after-market MFP upgrades.

In contrast, embodiments of the presently disclosed systems and methods for providing assistance in the use of MFPs allow help information to be easily updated by users and MFP vendors and distributed to users through the MFPs. In one aspect, help information and troubleshooting routines can be frequently updated as new information becomes available. In another aspect, help information and troubleshooting assistance provided by the MFPs can be customized to a particular user or vendor's product and needs. Beneficially, then, the assistance provided to users by the MFPs can result in quicker problem resolution, greater MFP usage, and the use of more advanced features of MFPs, increasing the productivity of users. These and other advantages of the disclosed embodiments are discussed in greater detail below.

In the embodiments discussed below, systems and methods for providing extended help information are discussed in the context of multi-function peripherals. It may be understood, however, that the disclosed embodiments may be applied to any electronic devices that are configured to provide help information to users operating the device and are not limited to MFPs.

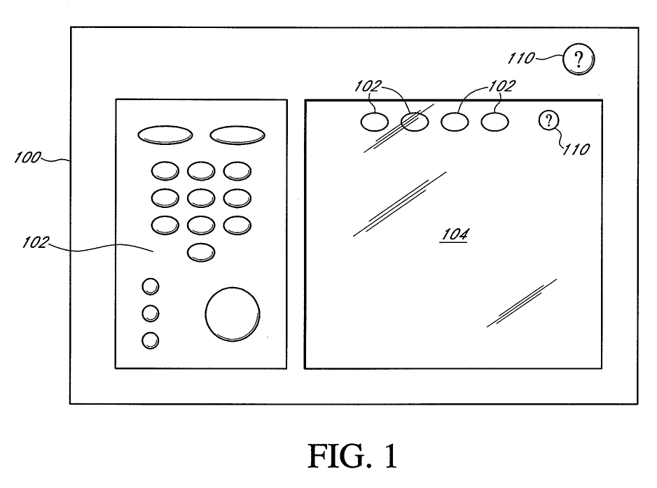

FIG. 1 presents one embodiment of an interface panel 100 of a MFP. The interface panel 100 is employed by MFP users in order to implement a plurality of functions of the MFP. In one embodiment, the interface panel 100 may comprise a plurality of buttons 102. In further embodiments, the interface panel 100 may comprise an electronic display 104, such as an LED display, which is capable of displaying combinations of text and images. The display 104 may further comprise a touch-sensitive display which presents graphical images of buttons (virtual buttons) that simulate the appearance and function of physical buttons, when pressed. In further embodiments, the interface panel 100 may comprise combinations of physical and virtual buttons 102, as necessary.

The interface panel 100 may further comprise a plurality of help buttons 110. The help buttons 110 may comprise physical buttons 102, virtual buttons depicted within the display 104, or combinations thereof. The MFP is configured such that, upon depression of the help buttons 110, help information is displayed to the user in the display 104 in order to assist the user in operation of the MFP.

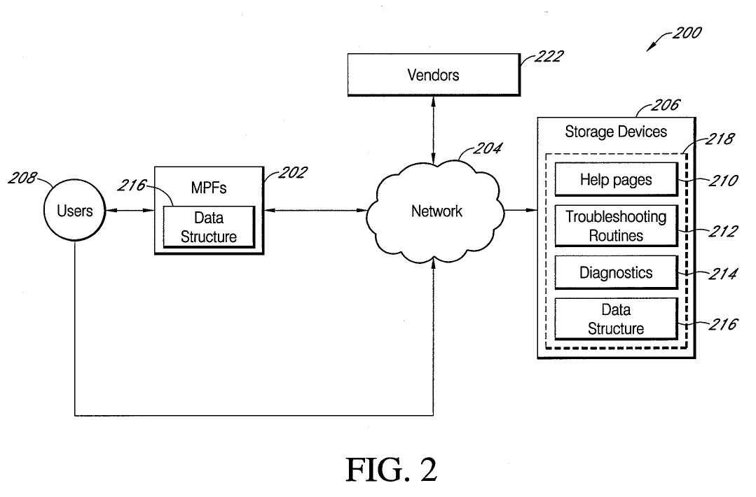

FIG. 2 illustrates one embodiment of an assistance system 200 for MFPs. The system 200 comprises a plurality of MFPs 202 and a plurality of storage devices 206 which are each in communication with a plurality of users 208 through a network 204. The storage devices may further be in communication with a plurality of vendors 222. The storage devices 206 maintain help information 218, which may be accessed by the MFPs 202 in response to a request for assistance from the user 208. The help information 218 may include, but is not limited to, help pages 210, troubleshooting routines 212, diagnostics 214, and data structures 216, as discussed below.

As discussed herein, the term users 208 includes its ordinary meaning and may further comprise individuals or collection of individuals, such as companies and other organizations, which utilize MFPs 202, as well their designated representatives. In one example, the users 208 may comprise employees of a company which owns or leases one or more MFPs 202. In another example, users 208 may comprise technical support staff retained by a company to maintain their MFPs 202.

As further discussed herein, the term vendors 222 includes its ordinary meaning and may further comprise individuals or collection of individuals, such as companies, which manufacture or sell MFPs 202, manufacture or sell hardware or software employed by MFPs 202, and providers of support services utilized by the MFPs 202. Examples of such services may include, but are not limited to, diagnostics, repair, consulting, research, and development employed by or for MFPs 202.

The MFPs 202, in an embodiment, comprise devices which incorporate the functionality of multiple devices in a single device. For example, the MFPs 202 may comprise devices capable of performing a plurality of functions including, but not limited to, printing, scanning, coping, and faxing. The MFPs 202 may be located in a single location or multiple locations, as necessary. The MFPs 202 may further communicate with each other through the network 204.

In one embodiment, the help information 218 comprises help pages 210 which provide documentation regarding a plurality of features of the MFPs 202. The features may include, but are not limited to, operation and maintenance of the MFPs 202. The help pages 210 may be provided in a variety of formats, including, but not limited to, text, images, animations, audio, video images, and combinations thereof. The help pages 218 may further comprise a plurality of indices. For example, a user 208 may select an item from an index, whereby in response, the MFPs 202 display the full content of the help page topic selected by the user 208.

In other embodiments, the help information 218 may comprise diagnostics 214 and/or troubleshooting routines 212. The diagnostics 214 and troubleshooting routines may be employed to identify relevant help pages 210 in order to resolve problems with the operation of the MFPs 202. For example, a user 208 may request the use of the diagnostics 214 and/or troubleshooting routines 212 to obtain assistance when a problem with the operation of the MFP 202 is encountered or suspected. In alternative embodiments, the diagnostics 214 and/or troubleshooting routines 212 may be automatically requested by the MFPs 202 upon detection of an error in operation.

In further embodiments, the help information 218 may comprise software. Periodically, MFP hardware manufacturers and MFP service providers may develop software which enhances the operation of the MFPs 202. Such software may further resolve known problems in the operation of the MFPs 202. Examples of software may include, but are not limited to, patches, service packs, firmware updates, and software applications which may be installed on the multi-function peripheral device.

In certain embodiments, the help information 218 provided to the user 208 may be context sensitive, directed to a particular function being employed by the MFP 202 or desired for use by the user 208. In one example, the context may be determined by the last known operation performed by the MFP 202 prior to the request for assistance. In another example, the context may be determined by the last known instructions provided to the MFP prior to the request for assistance. In a further example, the user 208 may depress the help button 110 and subsequently depress a plurality of buttons associated with a function of the MFP 202 to identify the desired help information. In response, the MFP 202 displays help information 218 regarding the selected function. Advantageously, context sensitive help information 218 allows the user 208 to quickly gain access to pertinent help information 218 for MFPs 202.

The help information 218 may further comprise a data structure 216, such as a database. When a help request is received by the storage devices 206, the storage devices 206 consult the data structure 216 in order to retrieve the appropriate help information 218.

In one embodiment, the users 208 may be physically present at the location of the MFP 202 when the MFP 202 is employed. For example, the users 208 may make selections using the interface panel 100 to implement one or more functions of the MFP 202. In alternative embodiments, the users 208 may be physically removed from the location of an MFP 202 when the MFP 202 is employed. For example, the users 208 may employ functions of an MFP 202 remotely, communicating with the MFP 202 through the network 204.

The storage devices 206 are in communication with the network 204 and comprise devices capable of storing the help information 218 and responding to requests for help information 218 from the MFPs 202. In further embodiments, the storage devices 206 may be located remotely from the MFPs and comprise server machines in communication with the network 204. The storage devices 206 store the help information 218 on a plurality of media including, but are not limited to, fixed media, such as hard disk drives, removable media, such as flash memory, magnetic tape, floppy disks, compact discs (CDs), digital versatile discs (DVDs), and combinations thereof.

In further embodiments, the storage devices 206 may be accessed by the third parties for the purpose of updating the help information The third parties may include, but are not limited to, users 202 of the multi-function peripheral, and vendors 222.

Updates may include, but are not limited to, adding new help information 218 and modifying previously stored help information 218. In one example, an MFP manufacturer may develop a plurality of revisions to help information 218 originally provided with factory shipped MFPs 202. In another example, new help information 218 pertaining to newly installed hardware can be added to the body of existing help information 218. Advantageously, in this manner, the MFP vendors 222 can seamlessly update the help information developed for the MFP throughout its life cycle.

In another embodiment, users 208 may develop their own versions of help information 218 which are different than that provided by the MFP manufacturer. For example, the IT department of a company may develop help information 218 which provides greater detail regarding MFP functions routinely performed by the company. In another example, help information 218 may be updated in response to feedback from individual users 208. In a further example, help information 218 pertaining to applications newly installed on the MFPs 202 may be added to the storage devices 206. As a result, different MFP users 208 may customize the help information 218 provided by their MFPs 202 to the needs of their organization, enhancing the utility of the help information 218.

Advantageously, through embodiments of the system 200, the MFPs 202 may be easily updated with new and revised help information 218 from a central location. This is in contrast to conventional MFP help systems, which typically require time consuming and labor intensive firmware updates in order to revise the help information stored by the MFPs.

The storage devices 202 may further maintain records regarding access of the help information 218. For example, records may be kept of the help information 218 which is most frequently requested and/or the duration of review. These records may be used to infer a variety of statistics, including, but not limited to, the frequency which users 208 request help information 218 and the duration over which help information 218 is reviewed. From this information, selected help information 218 may be revised and/or updated more frequently.

In one embodiment, such information may comprise the identity of users 208 who request help information 218. This information allows measurement of the frequency with which individual users 208 request assistance in using the MFPs 202 and may be further correlated with the features for which these users 208 request assistance. From this information, management may provide selected users 208 with additional training in the MFP 202 functions, enhancing the productivity of the users 208.

In additional embodiments, the storage devices 206 may record the frequency of help assistance requests, and associated help information 218, for individual MFPs 202. This information may be employed to determine when MFPs 202 are in need of maintenance. For example, if the number of troubleshooting requests for a selected MFP 202 increases above a selected threshold, it may be inferred that the MFP 202 is encountering a problem in functioning. As a result, a technician may be deployed to repair the MFP 202.

In an embodiment, communication between the users 208, MFPs 202, storage devices 206, and vendors 222, is accomplished through communications network 204. The network 204 may comprise Local Area Networks (LANs), Wide Area Networks (WANs), intranets, extranets, and the Internet. The communications network 204 may be further implemented using wired communication mechanisms, wireless communication mechanisms, and combinations thereof.

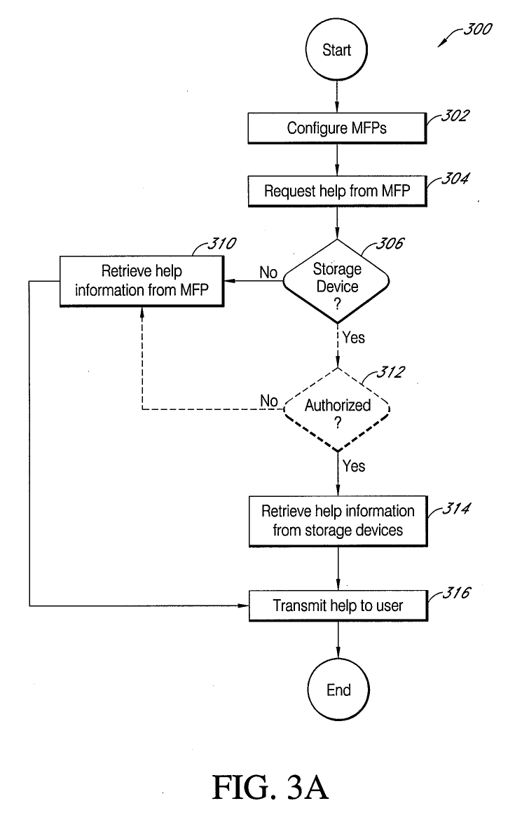

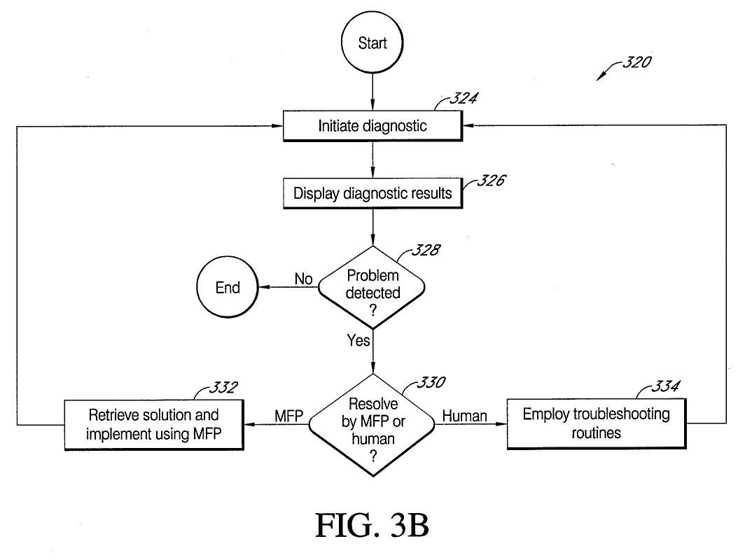

FIGS. 3A-3B illustrate embodiments of methods 300, 320 of using the assistance system 200 to obtain help information 218 in using an MFP 202. FIG. 3A illustrates a method of requesting help information 218 using the system 200, while FIG. 3B illustrates a method of requesting troubleshooting assistance using the system 200. It may be understood that the methods 300, 320 of FIG. 3A-3B may include additional or fewer blocks and the blocks may be performed in a different order than illustrated.

In block 302, the MFPs 202 are configured for use with the assistance system 200. In one embodiment, configuration may comprise installation of at least one of hardware, software, and firmware, which allow the MFPs 202 to communicate with the storage devices 206 when a user 208 requests help information 218. For example, configuration may comprise the installation of networking equipment which enables the MFP 202 to communicate with the storage devices 206 over the network 204.

In a further embodiment, configuration may comprise providing a plurality of configuration settings which allow the MFPs 202 to communicate with the storage devices 206 when a user 208 requests help information 218. For example, the MFP 202 may be provided with a plurality of network locations of the storage devices 206, such as URLs. In one embodiment, a single storage device 206 may store all the help information 218, and thus, a single network location may be provided during configuration. In other embodiments, a plurality of storage devices 206 may host the help information 218 and the network location of one or more of the storage device 206 may be provided.

In another example, the users 208 may select configuration settings which instruct the MFPs 202 how to obtain the help information 218. In one embodiment, the users 208 may instruct the MFPs 202 to obtain help information 218 only from the storage devices 206. In another embodiment, the users 208 may instruct the MFPs 202 to obtain help information 218 only from the MFPs 202. In additional embodiments, help information 218 may be obtained from combinations of the MFPs 202 and storage devices 206.

In a further embodiment the source of the help information 218 may be indeterminate. For example, the user 208 may select configuration settings which instruct the MFP 202 to obtain the help information 218 from one of a plurality of prioritized help information sources. The help information sources may comprise MFPs 202, storage devices 206, and combinations thereof. The source from which the MFP 202 obtains the help information 218 comprises the highest priority source which is in communication with the MFPs 202 at the time the help request is made by the user 208.

In block 304, a request for assistance is made to the MFP 202 (also referred to herein as a help request). In one embodiment, the act of making the help request may comprise user selection of a help button or icon 110 on the interface panel 100 of the MFP 202 by the user 208. In another embodiment, the help request may be made automatically by the MFP 202 itself.

Upon making the help request, a transmission requesting help information 218 is sent from the MFP 202 to the help information source. In one embodiment, the transmission specifies the help information 218 which is requested from the help information source. In one example, the user 208 may select a topic from an index of topics in order to identify the help information 218 which is to be delivered to the MFP 202. In another embodiment, the transmission may initiate an interactive query routine which asks the user a plurality of questions and, based upon the user's responses, selects and returns appropriate help pages 210.

In further embodiments, the transmission comprises information from which the help information 218 which is to be delivered to the MFP 202 can be inferred. In one example, the transmission may identify a page of the display 104 of the interface panel 100 from which the help request was made. In another example, the transmission may identify the last function performed by the MFP 202. In a further embodiment, the transmission may identify a plurality of functions performed by the MFP 202 over a selected time period prior to the transmission. In further embodiments, the help request may comprise an error code corresponding to a malfunction of the MFP 202.

In additional embodiments, the help request transmission may further include selected parameters about the MFP 202 making the request and/or of the request itself. This information may include, but is not limited to, the date the assistance request is sent, the time the assistance request is sent, the manufacturer of the multi-function peripheral device, the model of the multi-function peripheral device, the serial number of the multi-function peripheral device, the hardware, software, and/or firmware installed in the multi-function peripheral device, the operating system of the multi-function peripheral device, and/or applications running on the multi-function peripheral device at the time of sending the assistance request.

In block 306, the source from which the MFP 202 obtains the help information 218 is determined. In one embodiment, this determination may be made by the MFP 202 in accordance with the configuration settings discussed above. For example, the help information 218 may be retrieved from the storage devices 206, the MFPs 202, or from the highest of a prioritized list of help information sources. In alternative embodiments, the user 208 may manually select the help information source.

The method 300 moves to block 310 if the MFP 202 is to obtain help information 218 locally from itself, or to block 314 if the MFP 202 is to obtain help information 218 from the storage devices 206. In either case, the help information source may employ a data structure 216 to correlate the information provided in the help request with the corresponding help information 218. In one example, the data structure 216 may correlate topics selected by the user 206 from a help index with help information 218. In another example, the data structure 216 may correlate functions performed by the MFP 218 with help information 218. In a further example, the data structure 216 may correlate the pages of the display 104 of the interface panel 100 with help information 218. In an additional embodiment, the data structure 216 may correlate user responses to interactive queries with help information 218. In other embodiments, the data structure 216 may correlate MFP parameters with the help information 218. Thus, upon receiving the help request, the help information source consults the data structure 216 and retrieves the appropriate help information 218 for delivery to the MFP 202.

In one embodiment, the help information 218 stored locally by the MFP 202 comprises the help information 218 provided by the MFP manufacturer when the MFP 202 was shipped. Advantageously, in this manner, the locally stored information provides the user 206 with at least a default help information 218 in the event that storage devices 206 are unavailable, such as during a network outage.

In an alternative embodiment, the help information 218 stored locally by the MFP 202 comprises at least a portion of the help information 218 stored by the storage devices 206. In one embodiment, the MFP 202 may periodically query the storage devices 202 to determine whether updated help information 218 is available. If so, the MFP 202 may subsequently download at least a portion of the updated help information 218. In an alternative embodiment, the storage devices 206 may “push” updated help information 218 to the MFP 202.

In block 316, the help information 218 is provided to the user 208. In one embodiment, the help information 218 is displayed by the MFP 202 using the display 104 of the interface panel 100. In another embodiment, assistance system 200 may prompt the user 208 to provide an e-mail address to which the help information 218 is sent as an e-mail message. In further embodiments, the assistance system 200 may prompt the user 208 to provide a telephone number to which the help information may be sent in the form of a text or voice mail message. In additional embodiments, the user 208 may be provided with the address of a website or ftp site which provides the help information 218. In other embodiments, the user 208 may be provided with an instant messaging address which provides the help information 218. In further embodiments, any combination of these mechanisms may be employed.

In further embodiments, the method 300 may further comprise an authorization process in block 312. For example, the help request transmission may further comprise authorization information, such as an MFP serial number or password, which verifies that the MFP 202 may request information from the storage device 206. The data structure 216 of the storage device 206 may maintain a list of valid authorization information such that the storage device 206 only responds to help requests which include valid authorization information.

In the event that the help request is denied by the storage device 206, the method 300 moves to block 310, where the MFP 202 responds to the help request itself. Alternatively, in the event that the help request is accepted, the method 300 moves to block 314, where the storage device 206 responds to the help request. Beneficially, the authentication process inhibits unauthorized devices from accessing the storage devices 206 for help information 218, enhancing the security of the assistance system 200.

Use of an authentication procedure may further allow the assistance system 200 to be employed on a subscription basis. In one example, a user 208 may pay a fee for access to help information 218 stored by the assistance system 200. Such a fee may be based upon factors including, but not limited to, a number of MFPs 202 authorized to receive help information 218 from the storage devices 206, the duration of access, and the number of requests for help information 218 received by the storage devices 206.

Vendors 222 may additionally provide different tiers of help information 218. In one embodiment, higher tiers provide more comprehensive help information 218 in return for a greater access fee. In this manner, the help information 218 provided to the users 208 may be tailored both to the customer's support needs and financial constraints.

FIG. 3B illustrates one embodiment of a method 320 of troubleshooting problems encountered in use of the MFPs 202. In block 324, a request for assistance made, by the user 208, which initiates a diagnostic routine 214. The diagnostic 214 performs one or more of tests and analyses of hardware, software, and/or firmware to identify problems with the operation of an MFP 202. In one example, the diagnostic 214 may comprise a virus check. In another example, the diagnostic 214 may comprise a review of MPF 202 generated log files for errors. Such a diagnostic may be requested by the user 208 in response to an error in MFP operation.

In one embodiment, the diagnostic 214 is executed from the help information source which provides help pages 210 to the MFP 202. In another embodiment, the diagnostic 214 is executed from a help information source different than that which provides the help pages 210 to the MFP 202. For example, the diagnostic may be executed locally from the MFP 202 or remotely from the storage devices 206. This choice may be made automatically by the MFP 202 in accordance with an MFP configuration setting or manually by the user 208 when making the help request, as discussed above.

Upon completion of one or more diagnostics 214, the diagnostic results are provided to the user 208 in block 326. The user 208 may receive the results through a variety of mechanisms, as discussed in block 316 of FIG. 3A, including, but not limited to, display within the MFP 202, e-mail, text and/or voice messages, instant messaging, web sites, and ftp sites.

Following performance of the diagnostic 214, a determination is made in block 328 as to whether an MFP problem is present. In one embodiment, the determination is made by the assistance system 200. For example, the assistance system 200 may determine that no problem is present if the diagnostic 214 does not detect a problem. Conversely, the assistance system 200 may determine that a problem is present if the diagnostic 214 does detect a problem. In the event that a problem is detected, the method 320 moves to block 330. In the event that a problem is not detected, the method 320 ends.

In an alternative embodiment, the user 208 may determine whether a problem is present in block 328. In one example, the user 208 may review the results of the diagnostic 214 and choose to proceed with troubleshooting in block 330. In another example, the user 208 may review the results of the diagnostic 214 and choose to not proceed with troubleshooting and the method 320 ends.

In block 330, a determination is made whether the problem is to be addressed by the MFP 202 or not. In one embodiment, the decision is made by the assistance system 200. For example, the data structure 216 may comprise correlations between detected problems and recommended courses of action. The results of the diagnostic 214 are provided to the data structure 216, which generates a recommendation. The method 320 subsequently proceeds to MFP troubleshooting (block 332) or human troubleshooting (block 336), as recommended by the data structure 216.

In alternative embodiments, the user 208 may choose whether to allow the assistance system 200 to attempt to solve the problem or not. In one example, the assistance system 200 may analyze the problem and suggest a recommended course of action, as discussed above, which the user 208 approves. In another example, the user 208 may review the diagnostic results and make their own determination as to course of action.

When attempting problem resolution using the MFP 202, the method moves to block 332. Under certain circumstances, problems related to software, hardware, or firmware may be solvable by the MFP 202. Under such circumstances, the help information 218 returned to the MFP 202 may comprise instructions, executable by the MFP, to solve the problem

In certain embodiments, the MFP problem may comprise a software problem. Examples of such software problems may include, but are not limited to, corrupted or missing files. Under these circumstances, the MFP 202 may be instructed to download and install a plurality of files necessary to correct the problem. In one embodiment, such files may be stored in the storage devices 206, the MFP 202 itself, and combinations thereof. The files may be retrieved in accordance with the methods of retrieving help information 218 discussed above.

In other embodiments, the MFP problem may comprise a hardware problem. Examples of such software problems may include, but are not limited to, such as print head misalignment and print nozzle clogging. Under these circumstances, the MFP 202 may be instructed to use tools integrated into the MFP 202 to resolve the problem.

In another embodiment, human problem resolution is performed in block 334. For example, the interactive troubleshooting routines 212 may be employed to ask the user 208 a plurality of selected questions. The selected questions may be chosen from a plurality questions contained in the data structure 216 in response to the user's responses. The selected questions may be further chosen based upon MFP parameters received in the help request transmission. Based upon the users 208 responses and/or MFP parameters, the assistance system 200 may provide the user 208 with additional help documentation pertaining to the operation of the multi-function peripheral device. Such documentation may be employed to guide the user 208 through appropriate problem resolution procedures.

After troubleshooting has been attempted in blocks 332 or 334, the method 320 may optionally return to block 324, where the diagnostic 214 is run again to determine if the previously detected problems persist or if a new problem is detected. In circumstances where no problem is detected, the method 320 ends. In circumstances where a problem is still detected, the method 320 continues to block 330 for further troubleshooting.

Although the foregoing description has shown, described, and pointed out the fundamental novel features of the present teachings, it will be understood that various omissions, substitutions, and changes in the form of the detail of the apparatus as illustrated, as well as the uses thereof, may be made by those skilled in the art, without departing from the scope of the present teachings. Consequently, the scope of the present teachings should not be limited to the foregoing discussion, but should be defined by the appended claims.

What is claimed is:

1. A system incorporating a multi-function peripheral device, comprising:
at least one multi-function peripheral device, the multi-function peripheral device having a control interface that allows a user to provide instructions to the multi-function peripheral device which induces the device to perform copying, printing, scanning, faxing, or some combination thereof, wherein the at least one multi-function peripheral device includes a display where help information may be provided to the user while operating the multi-function peripheral device;
at least one central help server in communication with the at least one multi-function peripheral device, wherein the at least one central help server maintains a help information that can be provided to the at least one multi-function peripheral device in response to user operation of the at least one multi-function peripheral device; and
a network which is configured to allow communication between the at least one multi-function peripheral device and the at least one central help server and is further configured to allow a third party to communicate with the at least one central server and modify the help information maintained therein so that the modified help information can be provided to the user via the display in response to user manipulation of the at least one multi-function peripheral device.

2. The system of claim 1, wherein the help information comprises documentation pertaining to the operation of the multi-function peripheral device.

3. The system of claim 1, wherein the help information comprises a diagnostic configured to identify problems in the operation of the multi-function peripheral device.

4. The system of claim 1, wherein the help information comprises an interactive query routine which asks the user a plurality of questions and, based upon the user's responses, selects and returns documentation pertaining to the operation of the multi-function peripheral device.

5. The system of claim 1, wherein the third party comprises at least one of users of the multi-function peripheral, sellers of multi-function peripheral devices, sellers of hardware and software for use by multi-function peripheral devices, and providers of support services used by multi-function peripheral devices.

6. The system of claim 1, wherein at least a portion of the help information displayed to the user is retrieved from the central help server in response to user manipulation of the at least one multi-function peripheral device.

7. The system of claim 1, wherein at least a portion of the help information displayed to the user is retrieved from the central help server prior to user manipulation of the at least one multi-function peripheral device.

8. A method of providing assistance in use of a multi-function peripheral device having a display where help information may be provided to the user while operating the multi-function peripheral device, comprising:
electronically storing a help information for the multi-function peripheral device remotely from the multi-function peripheral device;
providing access to the remotely stored help information such that the remotely stored help information can be modified by at least one designated party;
delivering at least a portion of the remotely stored help information to the multi-function peripheral device; and
displaying at least a portion of the remotely stored help information delivered to the multi-function peripheral device via the display.

9. The method of claim 8, wherein the remotely stored help information delivered in response to a request for assistance which comprises a plurality of information which identifies at least a portion of the remotely stored help information to be delivered to the multi-function peripheral device.

10. The method of claim 9, further comprising consulting a data structure which correlates the plurality of information provided in the request for assistance with the remotely stored help information so as to identify at least a portion of the remotely stored help information to be delivered to the multi-function peripheral device.

11. The method of claim 8, wherein the remotely stored help information comprises documentation pertaining to the operation of the multi-function peripheral device.

12. The method of claim 8, wherein the remotely stored help information comprises an interactive query routine which asks the user a plurality of questions and, based upon the user's responses, selects and delivers documentation pertaining to the operation of the multi-function peripheral device.

13. The method of claim 8, wherein the remotely stored help information comprises a diagnostic configured to identify problems in the operation of the multi-function peripheral device.

14. The method of claim 8, wherein at least a portion of the remotely stored help information displayed to the user is delivered to the multi-function peripheral device in response to a request from the multi-function peripheral device during user manipulation of the multi-function peripheral device.

15. The method of claim 8, wherein the remotely stored help information is automatically delivered to the multi-function peripheral after modification of the remotely stored help information by the at least one designated party.

16. The method of claim 8, wherein the at least one designated party comprises at least one of users of the multi-function peripheral, sellers of multi-function peripheral devices, sellers of hardware and software for use by multi-function peripheral devices, and providers of support services used by multi-function peripheral devices.

17. The method of claim 8, further comprising installing an application on the multi-function peripheral device and modifying the remotely stored help information with documentation regarding the newly installed application.

18. A method of providing assistance in the operation of a multi-function peripheral device configured to display help information to a user of the device, comprising:
sending a request for assistance from the multi-function peripheral device to at least one server located remotely from the multi-function peripheral in response to user manipulation of the multi-function peripheral device, the server comprising a help information and a data structure containing correlations between a plurality of MFP diagnostic results and the plurality of help information;
executing a diagnostic in response to the request for assistance to obtain at least one MFP diagnostic result;
sending the at least one MFP diagnostic result to the at least one server and displaying the at least one MFP diagnostic result to the user,
electronically identifying the help information correlated with the least one MFP diagnostic result using the data structure; and
transmitting the correlated help information to the multi-function peripheral device so as to provide recommendations for troubleshooting resolution;
wherein the at least one server is configured for access by at least one third party so as to permit modification of the help information and data structure stored by the at least one server that modified help information can be displayed to the user.

19. The method of claim 18, wherein the request for assistance further comprises a plurality of parameters regarding the multi-function peripheral device.

20. The method of claim 19, wherein the plurality of parameters comprises at least one of the date the assistance request is sent, the time the assistance request is sent, the manufacturer of the multi-function peripheral device, the model of the multi-function peripheral device, the serial number of the multi-function peripheral device, the hardware installed in the multi-function peripheral device, the operating system of the multi-function peripheral device, applications installed on the multi-function peripheral device, applications running on the multi-function peripheral device at the time of sending the assistance request, actions performed by the multi-function peripheral device over a selected time period prior to sending the assistance request.

21. The method of claim 19, further comprising an interactive query routine which asks the user a plurality of questions and, based upon at least one of the user's responses and the MFP parameters, provides the user with a plurality of troubleshooting steps to perform.

22. The method of claim 18, wherein the third party comprises at least one of users of the multi-function peripheral, sellers of multi-function peripheral devices, sellers of hardware and software for use by multi-function peripheral devices, and providers of support services used by multi-function peripheral devices.

23. The method of claim 18, wherein the help information comprises documentation pertaining to the operation of the multi-function peripheral device.

24. The method of claim 18, wherein the help information comprises instructions to obtain at least one of patches, service packs, firmware updates, and software applications which may be installed on the multi-function peripheral device to resolve an identified problem in the operation of software of the device.

25. The method of claim 18, wherein the help information comprises instructions for the multi-function peripheral device to employ the use of at least one tool integrated into the device to resolve an identified problem in the operation of hardware of the device.

26. A multifunction peripheral device, comprising:
a control interface that allows a user to provide instructions to the multi-function peripheral device which induces the device to perform copying, printing, scanning, faxing, or some combination thereof; and
a display capable of providing help information to the user while operating the multi-function peripheral device;
wherein at least a portion of the help information for the multifunction peripheral device is stored remotely from the device and wherein the remotely stored help information may be accessed and modified so that the modified help information can be provided to the user via the display in response to user manipulation of the at least one multi-function peripheral device.

27. The multifunction peripheral device of claim 26, wherein the remotely stored help information comprises documentation pertaining to the operation of the multi-function peripheral device.

28. The multifunction peripheral device of claim 26, wherein the remotely stored help information comprises a diagnostic configured to identify problems in the operation of the multi-function peripheral device.

29. The multifunction peripheral device of claim 26, wherein at least one of users of the multi-function peripheral device, sellers of multi-function peripheral devices, sellers of hardware and software for use by multi-function peripheral devices, and providers of support services used by multi-function peripheral devices possess are permitted to access and modify the remotely stored help information.

30. The multifunction peripheral device of claim 26, wherein at least a portion of the remotely stored help information displayed to the user is retrieved prior to user manipulation of the at least one multi-function peripheral device.
